(19) United States
(12) Patent Application Publication
(10) Pub. No.: US 2015/0254806 A1
(43) Pub. Date: Sep. 10, 2015

(54) Efficient Progressive Loading Of Media Items

(71) Applicant: Apple Inc., Cupertino, CA (US)

(72) Inventors: Eric Circlaeys, Paris (FR); Kjell Bronder, San Francisco, CA (US); Ralf Weber, San Jose, CA (US)

(73) Assignee: Apple Inc., Cupertino, CA (US)

(21) Appl. No.: 14/200,716

(22) Filed: Mar. 7, 2014

(51) Int. Cl. G06T 3/40

(52) U.S. Cl. CPC G06T 3/4038

(57) ABSTRACT

A set of media items may be matched with a media arrangement that displays the media items in the set in a group of frames having various sizes and positions. The media arrangement may extend across an area that is larger than a viewable area of a display device on which the media arrangement is displayed. A user may adjust (e.g., scroll) the viewable portion of the media arrangement. Because the media arrangement may include a large number of media items, it may not be feasible or possible to retrieve and load all of the media items into media frames in advance. Thus, a method and system may be used to progressively load media items into media frames for the viewable area and to pre-fetch media items for areas of the media arrangement that may be displayed after the current viewable area.

### BACKGROUND

This disclosure relates generally to techniques to display a group of media items in an optimal media arrangement. More particularly, the disclosure relates to techniques to efficiently retrieve and load media items for displaying in a media arrangement.

With the rapid increase in the number of devices capable of capturing digital media and the number of repositories for such media, there exists a need for an interface that is capable of aggregating, sorting, and displaying all—or a substantial portion—of the media to which a user has access to in a visually pleasing manner. Because media items may be stored on various sources (e.g., local device storage, remote social networking services, remote storage services, etc.), a user interface that presents multiple media items to the user in a visually pleasing manner should be able to retrieve the media items efficiently. In addition, because many of the devices capable of capturing and displaying such media items have relatively limited memory and processing capabilities (e.g., mobile devices such as phones, tablets, and PDAs), the user interface should be capable of retrieving and storing the media items in an efficient manner such that storing the media items does not result in memory storage constraints, yet allows for the items to be displayed seamlessly and in a manner that improves the user experience.

### SUMMARY

TO be filled in after finalizing claims.

### BRIEF DESCRIPTION OF THE DRAWINGS

FIG. 1 illustrates the aggregation of media items from multiple media sources for display in a media arrangement in accordance with one embodiment.

FIG. 2 illustrates a set of media items displayed in a visually pleasing media arrangement and depicts a viewable area of the media arrangement in accordance with one embodiment.

FIG. 3 is a block diagram that illustrates an architecture for retrieving and storing media items in accordance with one embodiment.

FIGS. 4A-4E are flowcharts for media retrieval, storage and loading operations for setting media items into media frames for a media arrangement in accordance with one embodiment.

FIG. 5 is a flow chart for performing pre-fetch of media items for a media arrangement in accordance with one embodiment.

FIG. 6 shows priority levels for operations and provides an example of how different priority operations may be ordered in accordance with one embodiment.

FIG. 7 shows an illustrative electronic device in accordance with one embodiment.

### DETAILED DESCRIPTION

This disclosure pertains to systems, methods, and computer readable media for displaying selected media items in a manner that enhances the user experience. In general, a set of media items may be matched to, and displayed in accordance with, one of a number of predefined media arrangements as described in the co-pending applications entitled “Semi-Automatic Organic Layout for Media Streams” (Ser. No. 14/080,522), “Multi Source Media Aggregation” (Ser. No. 14/080,553), and “Viewable Frame Identification” (Ser. No. 14/080,591), the contents of which are incorporated herein by reference. Media items that are displayed in a media arrangement may be stored on different sources (e.g., local device storage, remote social networking services, remote storage services, etc.), some of which may be accessed via a network. Retrieving media items that are stored remotely and are accessed over a network may require more time than is available when a user is quickly interacting with (e.g., scrolling through) a media arrangement. This may result in an automatic slowing or stopping of the scrolling operation to wait for all media items to be retrieved, or it could result in having blank media frames in the visible area of the media arrangement, both of which can negatively impact the user experience. It may also not be possible or advisable to retrieve all such media items in advance, because of memory storage and/or processing limitations on the device on which the media arrangement is being displayed. In one embodiment, a multi-level cache system and asynchronously tuned retrieval and loading operations may be used to retrieve and load media items progressively and in an optimized manner as the user views the media arrangement.

In the following description, for purposes of explanation, numerous specific details are set forth in order to provide a thorough understanding of the inventive concept. As part of this description, some of this disclosure's drawings represent structures and devices in block diagram form in order to avoid obscuring the invention. In the interest of clarity, not all features of an actual implementation are described in this specification. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

It will be appreciated that in the development of any actual implementation (as in any development project), numerous decisions must be made to achieve the developers' specific goals (e.g., compliance with system- and business-related constraints), and that these goals will vary from one implementation to another. It will also be appreciated that such development efforts might be complex and time-consuming, but would nevertheless be a routine undertaking for those of ordinary skill in the art of data processing having the benefit of this disclosure.

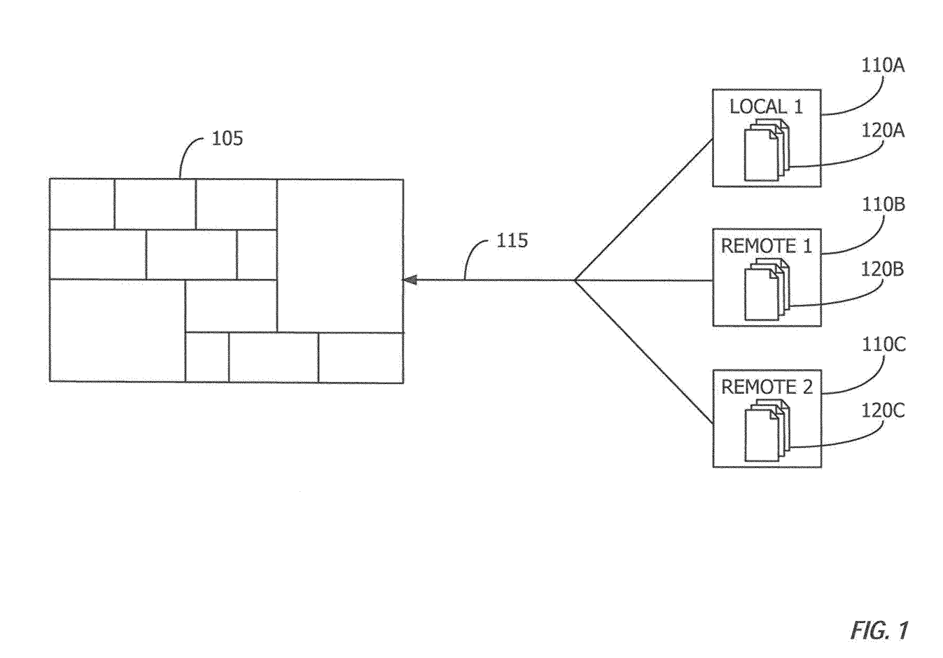

Referring to FIG. 1, an optimal media arrangement 105 of multiple media frames to display a stream of media items 115 may be selected from a set of predefined media arrangements. The media items in stream 115 may include items available from one or more local sources (e.g., a local image editing application, a local image library, etc.) and/or one or more remote sources (e.g., a social networking service, a remote storage service, a remote image editing service, etc.). In the illustrated embodiment, a user request to display media items may result in the determination of optimal media arrangement 105 to accommodate media items from first local source 110A, first remote source 110B, and second remote source 110C. By way of example, a user may submit a request to view all of the media items associated with a particular individual (e.g., the user's own media items or the media items of another individual to which the user has access) or may provide specific criteria for desired media items (e.g., media items for one or more individuals and from a set of sources). Based on the user's request, each of the relevant sources may be queried to determine whether any media items satisfying the request are available. The request may result in the determination that media items 120A from source 110A, media items 120B from source 110B, and media items 120C from source 110C all satisfy the criteria identified in the request.

Once the media items that satisfy the required criteria are identified, a determination may be made as to how to order the identified media items to achieve optimal media arrangement 105. This may involve evaluating the properties of the ordered media items against the properties of a set of predefined media arrangements to identify the most appropriate media arrangement (e.g., media arrangement 105). Once an optimal media arrangement has been identified, it may be necessary to retrieve the identified media items to be able to present the media arrangement in a visually pleasing manner. However, because the number and/or size of the media items may be large, it may not be feasible to retrieve all of the identified media items in advance, as the time it takes to retrieve all the media items may be too long. For example, it is possible that the user would desire to view the optimal media arrangement as soon as it has been created, thus not leaving enough time for all of the media items to be retrieved and loaded in advance. Moreover, even if there is enough time to retrieve all of the media items in advance, it may still not be desirable or even possible to do so because of memory storage constraints. Thus, a method is needed to efficiently and progressively retrieve media items and load them into their respective media frames in the media arrangement.

As the number of media items identified for an optimal media arrangement may be large, only a subset of the media items may appear within a viewable portion of the media arrangement at any given time. Each media item may be displayed in a media frame in the viewable portion of the media arrangement. Thus, each media frame may be associated with a media item when it is being prepared to be displayed. As the viewable portion changes, the media frame may no longer need to be associated with a previously viewed media item. This allows a presentation engine or a shipping framework (e.g., UICollectionView, in one embodiment—not shown) to use a limited number of media frames by purging and reusing the same media frames for new media items as the viewable portion changes. In this manner, user interface resources involved can be optimized, thus increasing efficiency. As the user interacts with the display of media items in the media arrangement (e.g., scrolls through the media items), the system may identify which portion of the media arrangement, and consequently which media items, are viewable at any given time.

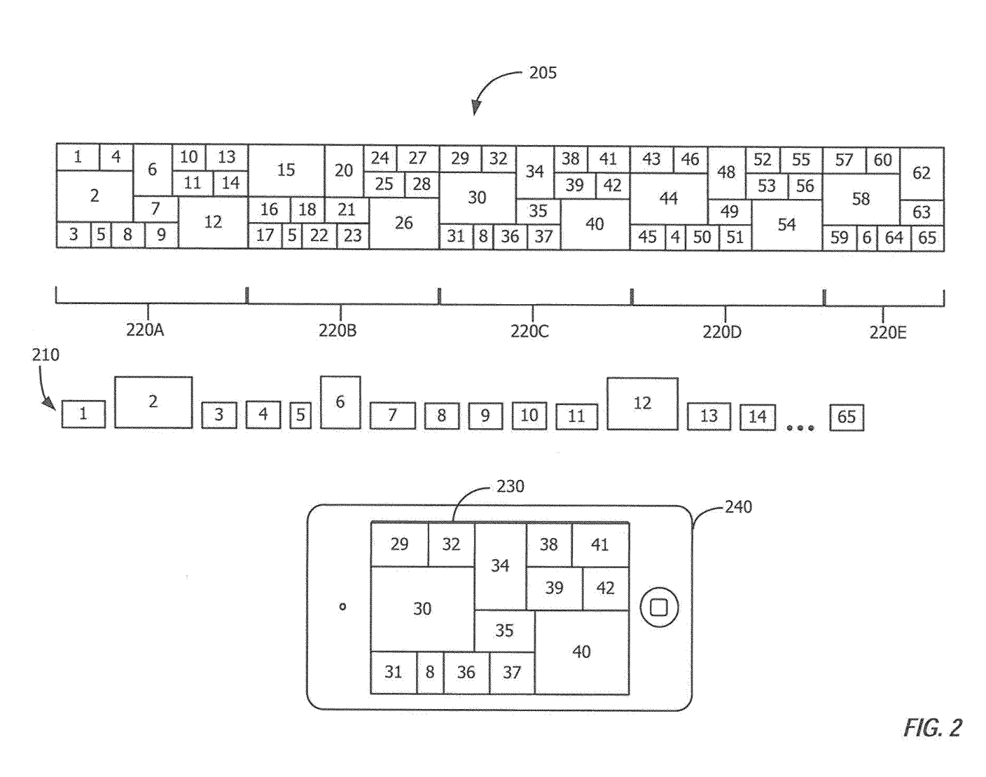

Referring to FIG. 2, optimal media arrangement 205 made up of a list of identified media items 210 is illustrated. Media arrangement 205 may be made up of multiple media pages 220A-220E. When viewing media arrangement 205 on a device, such as device 240, the user may be able to view only the portion of the media arrangement that fits display screen 230 at any given time. In one embodiment, each media page is configured to fit the size of display screen 230 such that the user can view the media arrangement one page at a time. Alternatively, two or more pages may be viewed on display screen 230 at a given time. In another embodiment, the user may be able to move the media arrangement (e.g., scroll through it) in a way that a portion of one page and a portion of the next or the previous page are presented on display screen 230 at the same time.

As discussed above, media items 210 in each page of the media arrangement 205 may be stored in multiple sources, some of which may be remote. When a user is quickly interacting with media arrangement 205 (e.g., scrolling through the pages), the time it takes to retrieve some of the media items 210 and load them into a media frame for presentation to the user may be longer than the time it takes the user to move through the pages of the media arrangement. This may result in one or more blank media frames in a visible area of the media arrangement or may cause delays in scrolling through the media arrangement, which could negatively impact the user experience.

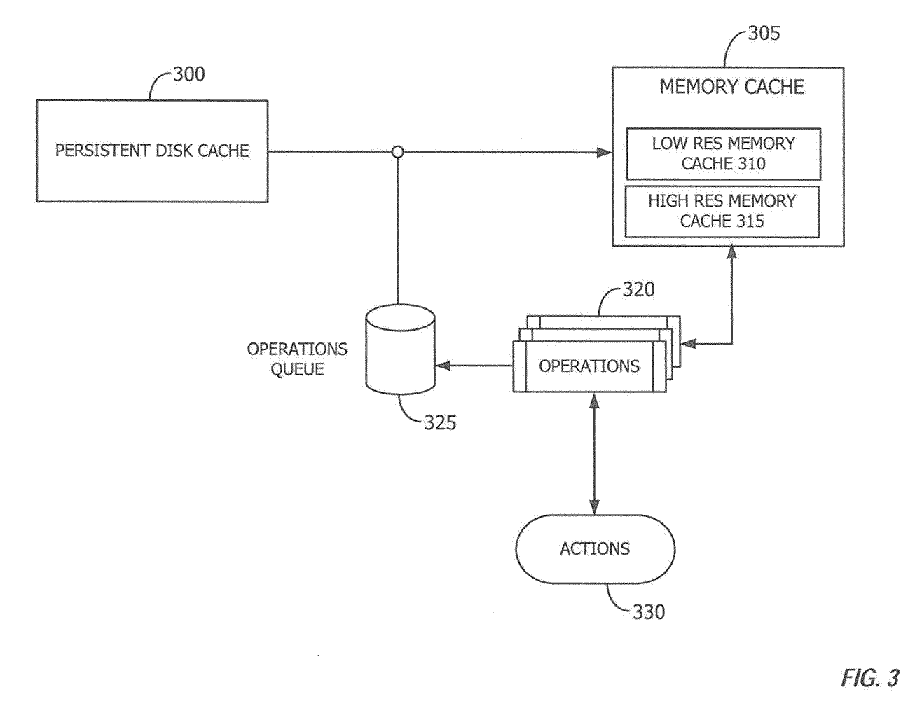

To resolve these issues, techniques may be utilized that make use of multiple levels of resolution for each media item, multiple levels of memory caches, asynchronous tuned operations (e.g., by thread priority, dependencies, and/or scheduling priorities), image decompression, and/or prefetching procedures to progressively retrieve and load media items. Referring to FIG. 3, the memory architecture used, in one embodiment, may include persistent disk cache 300 and multiple levels of memory cache 305. Persistent disk cache 300 may be used for storing media items of any resolution. Persistent disk cache 300 may also be used for caching media items from both local and remote sources to limit the number of queries and thus limit latencies. In one embodiment, media items on persistent disk cache 300 are stored at a less than 100% level of quality in order to reach an optimized balance between file size, image quality, and decompression time. For example, media items may be stored at 80% quality to reduce file size and decompression time, yet still maintain a reasonable visual or display quality. In order to avoid having a growing disk cache space, a maximum number may be set for the number of media items than can be stored on persistent disk cache 300. When the maximum number is reached, a purge mechanism may be applied upon application termination to reduce the number of media items on persistent disk cache 300. In one embodiment, the maximum number may be 16384 media items which may equate to approximately 1.5 GB. The purge mechanism may also be performed occasionally during the operation, in one embodiment.

Memory cache 305 may include two or more separate memory cache portions. In one embodiment, memory cache 305 may be segmented into a low resolution volatile memory cache 310, and a high resolution volatile memory cache 315. Low resolution LRU memory cache 310 may be used to store low resolution media items and high resolution LRU memory cache 315 may be used to store high resolution media items. This is because two or more levels of resolution may be available for each media item. A lower resolution version of the media item may require less time to retrieve and load and also less storage space, and may thus be used when saving time and/or space is more important than having a higher resolution media item. The low resolution version may also be used for different media frames regardless of the size of the media frame, while the higher resolution media item may selected such that its' size corresponds to the size of the media frame to which it is being loaded. Additionally, the low resolution media item may be usable across different media arrangement layouts and orientations

The media items from persistent disk cache 300 may be loaded into memory cache 305 on demand. In one embodiment, memory cache 310 and memory cache 315 may be administered as least recent used (LRU) caches. That is, after a media item is loaded into memory caches 310 or 315, the media item may be sent back to disk cache 300 upon memory pressure and in accordance with memory cleanup protocols. For example, if a media item corresponding to a certain group path has not been accessed from memory cache 310 or 315 for a specific period of time, the media item may be dropped from memory cache 310 or 315 and sent to disk cache 300. In one embodiment, the memory item dropped from memory cache 310 or 315 is not sent back to disk cache 300. By removing the least recent used memory item(s), LRU memory caches can keep the memory below a certain storage limit and thus prevent memory pressure. In an alternative embodiment, the LRU memory may remove memory items that have not been used in a specific period of time to keep memory below a certain storage limit.

One or more actions 330 such as a media item retrieval request may result in the performance of one or more operations 320. Operations 320 may be queued in operations queue 325, and upon execution of a particular operation, the media item corresponding to the operation may be retrieved from persistent disk cache 300 and loaded into memory 305. All operations 320 may concurrently access memory 305.

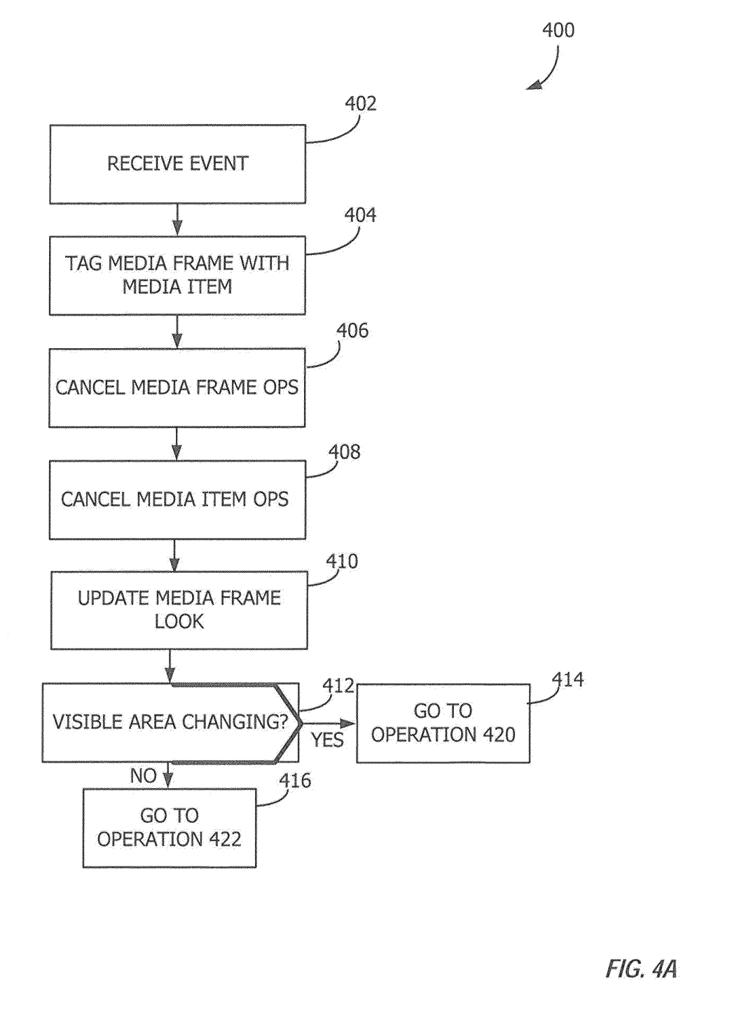

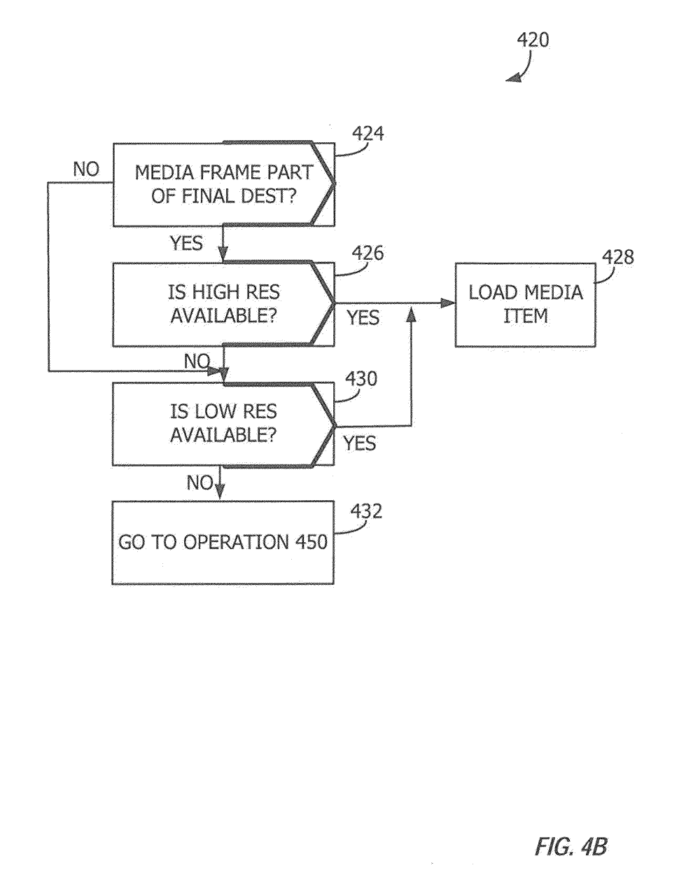

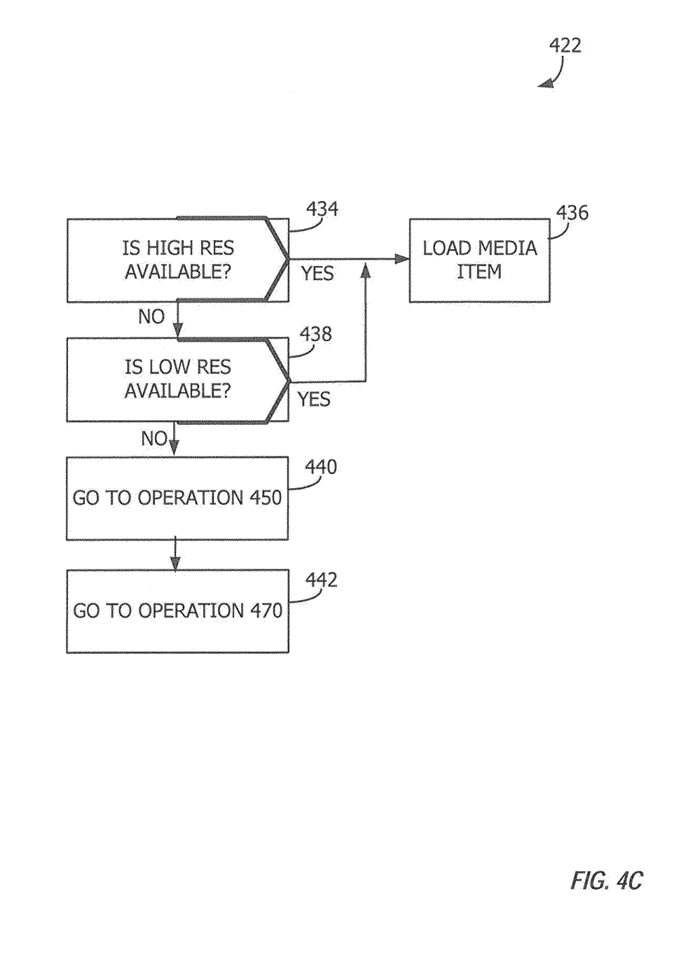

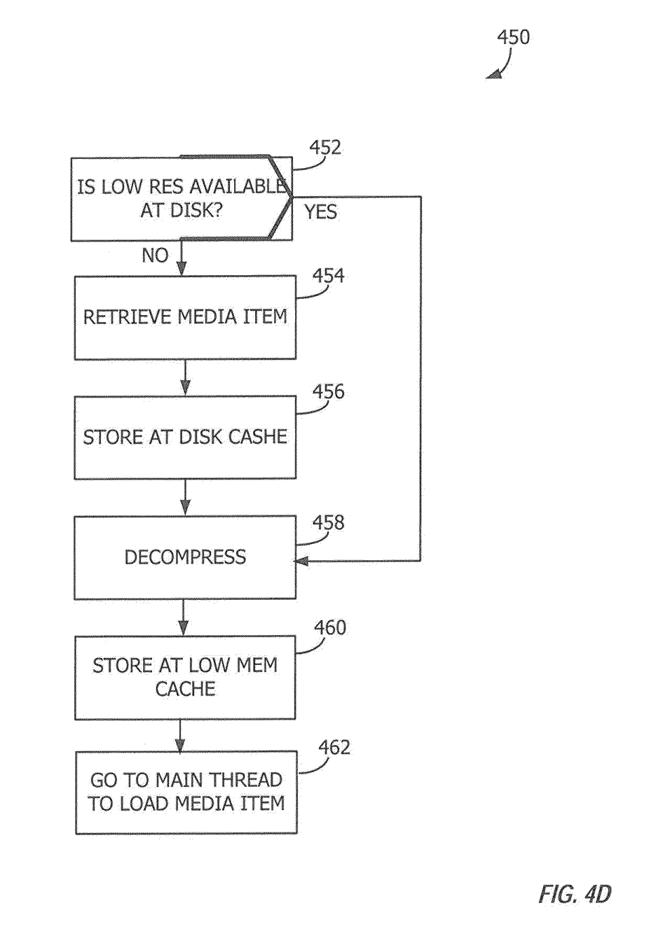

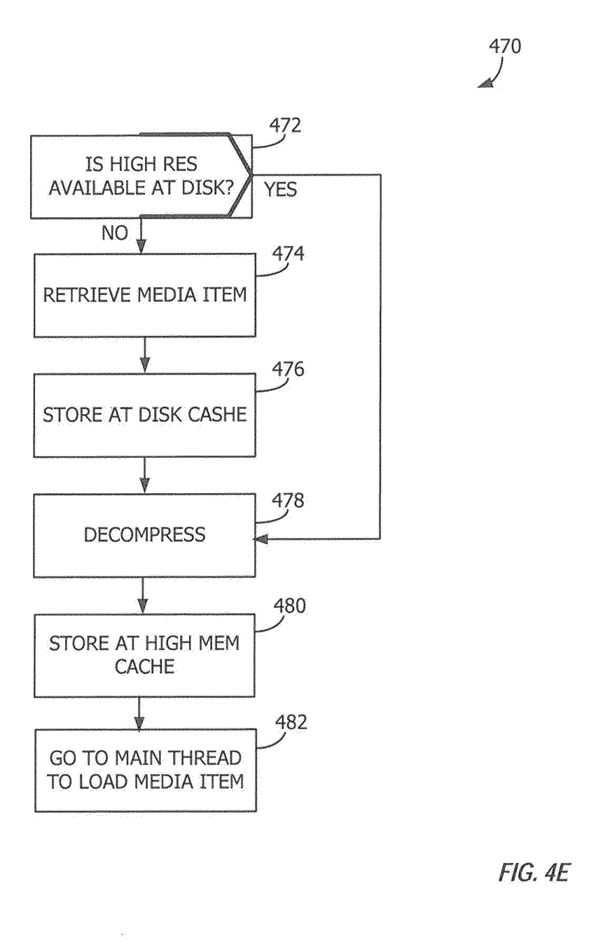

Referring to FIG. 4A, in accordance with one embodiment, operation 400 for loading and/or retrieving media items begins when an event which triggers loading or reusing of a media frame is received (block 402). The event could be, for example the launching of the application for creating optimal media arrangements, or the user selecting a particular media arrangement for viewing. Alternative events may be the start of scrolling through the media arrangement or the end of scrolling. Regardless of the type of event received, the operation 400 is generally performed for a media frame when the media frame is being displayed or is about to be displayed in a viewable portion of the media arrangement and the media frame is not already loaded with a media item. In another embodiment, the operation may be performed for a media frame that becomes available for being reused or recycled. This may happen during scrolling, when as a result of the viewable portion changing, a media frame is no longer needed to be associated with a previously viewed media item. As mentioned before a limited number of media frames may be used for the media arrangement. Thus when the user views and passes a media frame by scrolling past it, that media frame may become available for reuse.

Regardless of how the operation 400 begins, after it has started first the media frame is associated with the media item that will be loaded into the media frame in accordance with the defined media arrangement (block 404). This may involve updating the media frame data source path index to point to the specific media item.

After the media frame is associated with the new media item, all previously scheduled and/or running operations for that media frame may be canceled (block 406). This step may be needed because as will be described in detail below many operations may be scheduled and/or performed simultaneously, and various user interactions with the media arrangement may result in changing the priority or the need for some of those operations. For example, if the media item associated with the media frame of operation 400 is being retrieved or pre-fetched (or is scheduled to be retrieved or pre-fetched) in other operations, such operations may be canceled at this stage (block 408).

After cancelations steps of blocks 406 and 408, the visual features of the media frame may be updated in accordance with the associated media item (block 408). This may involve updating a title of the media frame, a badge, or other similar features, After updating the look of the media frame, the operation 400 may determine if the visible area of the media arrangement is changing (i.e., there is scrolling) (block 412). In one embodiment, the determination of whether the visible area is changing is made based on a threshold speed. If the visible area is changing at a speed that is lower than a predetermined threshold, then the procedure may consider that as the visible area not changing. If it is determined that the visible area is changing, the procedure moves to operation 420 of FIG. 4B (block 414). If the visible area is not changing (i.e., there is no scrolling), the procedure moves to operation 422 of FIG. 4C (block 416).

Operation 420 begins by determining if the media frame will be part of a final destination of the media arrangement (i.e., the media frame will be presented on a stationary viewable area of the media arrangement when scrolling stops) (block 424). This may be determined in one embodiment by calculating the rate of deceleration of scrolling, identifying the location of the media frame in the media arrangement and calculating the relation between the location and the rate of deceleration. Alternative embodiments may be used for determining whether the media frame will be part of a statutory viewable area.

If it is determined the media frame will be part of the final destination viewable area (the “YES” prong of block 424), the operation may then determine if a high resolution version of the associated media item is available in high resolution memory cache 315 (block 426). This is because if the media frame will be part of the final destination and as such presented to the user in stationary form, it may be preferable to use the high resolution version of the media frame for better quality viewing. However, if the media frame is being presented to the user during scrolling, it may be more important to quickly retrieve and/or upload the media item than to present a higher quality image, particularly since the media item is only presented to the user in passing.

If the operation determines that a high resolution version of the media item is available (the “YES” prong of block 426), the high resolution media item may be loaded into the media frame (block 428). If it is determined at block 424 that the media frame will not be part of the final destination viewable area (the “NO” prong of block 424) or it is determined at block 426 that a high resolution version is not available, then the operation may check low resolution memory cache 310 to determine if a low resolution media item is available for loading (block 430). When the low resolution version of the media item is available (the “YES” prong of block 430), the media item may be loaded into the media frame (block 428) thus completing operation 420 and consequently operation 400.

When it is determined that a low resolution version of the media frame is not available at the low resolution memory cache 310 (the “NO” prong of block 430), the operation may move to operation 450.

FIG. 4C illustrates steps of operation 422 which are perfumed after it is determined at block 412 of FIG. 4B that the visible area is not changing. When the visible area is not changing (i.e. no scrolling), presenting high resolution images may become more important and the operation may thus check for high resolution versions first. As such, operation 422 may begin by determining if a high resolution version of the media item is available at the high resolution memory cache 315 (block 434). If the high resolution version of the media item is available (the “YES” prong of block 434), the high resolution media item may be loaded into the media frame (block 436). If it is determined that a high resolution version is not available, or after the high resolution version has been loaded, then the operation may check low resolution memory cache 310 to determine if a low resolution media item is available (block 438). When the low resolution version of the media item is available (the “YES” prong of block 438), the media item may be loaded into the media frame (block 439) thus completing operation 422 and consequently operation 400.

When neither the high resolution nor the low resolution version of the media item is available at the memory cache 305, the procedure may move to operation 450 first and then move to operation 470. This means that both operations 450 and 470 may be scheduled and running at the same time. However, the two operations may have different priorities and may be running in different priority threads. Generally operation 450 which involves retrieving a low resolution version of the media item is of a higher priority than operation 470 which relates to retrieving a high resolution version of the media item. Both of these operations may also run in secondary threads, while operations 400, 420 and 422 may run in the main thread. This ensures that while higher resolution media items are being retrieved for better quality display, media items are also being loaded into the next media frame(s) for fast access.

Referring to FIG. 4D, operation 450 may begin by determining if the low resolution version of the media item is available at disk cache 300 (block 452). If so (the “YES” prong of block 452), the operation moves to block 458 to decompress the low resolution media item. However, if the low resolution version is not available at disk cache 300 (the “NO” prong of block 452), then it may be retrieved from its source (e.g., local or remote source) (block 454) and stored at disk cache 300 (block 456). The media item may then be decompressed (block 458) to prepare it for immediate use and the decompressed media item along with its compressed data may be stored in low resolution memory cache 310 (block 460) for efficient loading into the media frame. In one embodiment, decompressing the media item may occur in a separate thread for efficiency. The operation may then move back to block 428 or block 436 in the main thread to load the stored media item into the media frame (block 462).

Referring to FIG. 4E, operation 470 is generally performed when the viewable area is not changing and thus more time and/or resources are available for retrieving high resolution media items. As such, operation 470 may begin by determining if the high resolution version of the media item is available at disk cache 300 (block 472). If the high resolution version of the media item is available (the “YES” prong of block 472), the operation may move to block 478 to decompress the high resolution media item. However, if the high resolution version is not available at disk cache 300 (the “NO” prong of block 472), then it may be retrieved from its source (e.g., local or remote source) (block 474) and stored at disk cache 300 (block 476). The media item may then be decompressed (block 478) to prepare it for immediate use and the decompressed media item along with its compressed data may be stored in high resolution memory cache 315 (block 480) for efficient loading into the media frame. In one embodiment, decompressing the media item may occur in a separate thread for efficiency. The operation may then move back to block 428 or block 436 in the main thread to load the stored media item into the media frame (block 482).

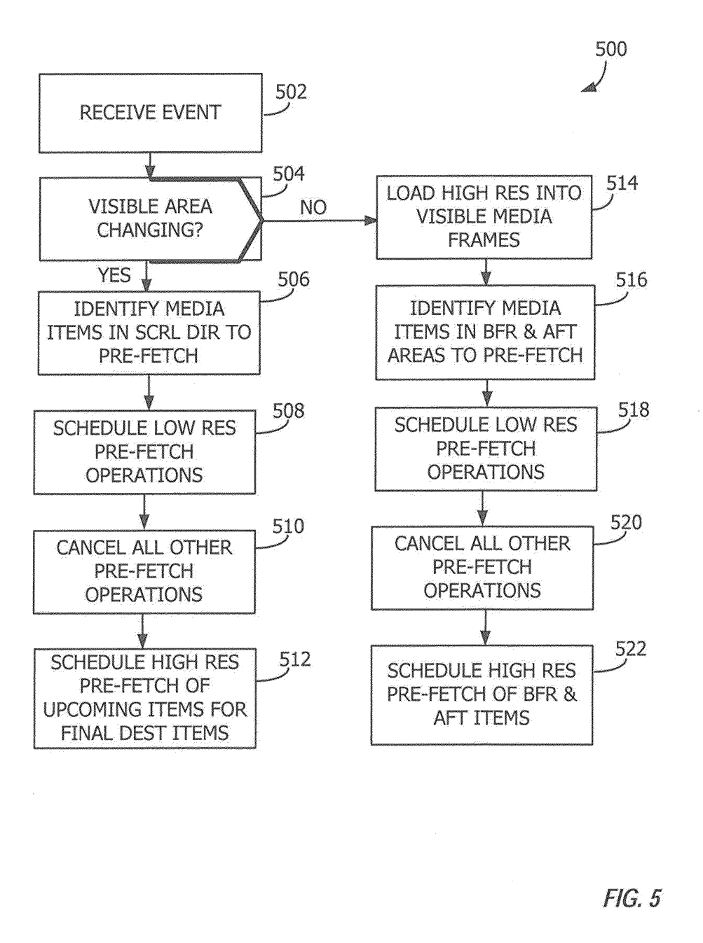

In one embodiment, in order to ensure a smooth transition between pages of the media arrangement as the visible area changes and to reduce the chances of encountering a blank media frame, it may be advantageous to pre-fetch media items. FIG. 5 illustrates a flow chart for an operation 500 involving such pre-fetching.

In accordance with one embodiment, operation 500 for pre-fetching media items begins by reviving a triggering (block 502). The triggering event could be, for example the launching of the application for creating optimal media arrangements, the user selecting a particular media arrangement for viewing, or the start or stopping of scrolling. During continuous scrolling, a triggering event may be the recognition that the visible area is continuously changing. Once such a triggering event is received, operation 500 may first determine if the visible area is changing (i.e. scrolling is in progress) (block 504). If the visible area is changing (the “YES” prong of block 504), then operation 500 may identify media items in the upcoming visible areas that need to be pre-fetched (block 506).

In one embodiment, the operation may identify media items that correspond to an area of the media arrangement that will be made visible next. To do this, in one embodiment, the operation may select media items in the page adjacent to the current visible area in the direction of scrolling. The number of media items that may be identified for pre-fetching may vary. In one embodiment, the operation may identify media items corresponding to the next two visible areas in the direction of scrolling. Alternatively, the operation may identify media items for just the next visible area. In another embodiment, the operation may identify media items corresponding to the next three visible areas. In yet another embodiment, the operation may identify media items for up to ‘n’ visible areas in the direction of scrolling.

Once all of the media items that need to be pre-fetched have been identified, the operation 500 may schedule pre-fetching operations separately for each of those media items to retrieve low resolution versions of those media items that are not already available in the low resolution cache (block 508). The pre-fetch operations scheduled are similar to the operation 450 in that they include steps for determining if the low resolution version of the media item is available at the low resolution cache and if not retrieving the low resolution version, storing it at the disk cache, decompressing it, and then storing it in the low resolution cache.

In one embodiment, the pre-fetch operations may be scheduled in order of priority. Generally, priority may be given to media items that will be viewable closest to the current visible media frames. Thus, if, for example, media items for the next two visible areas are being pre-fetched, the media items for the next visible area are scheduled to be pre-fetched first, and among those media items the ones closest to the edge of the current visible area are given the highest priority.

After scheduling these pre-fetch operations, the procedure may cancel all other previously pending pre-fetch operations (i.e., not the ones that were just scheduled) (block 510). That is because, as the user goes through the media arrangement (e.g., by scrolling through the media arrangement) prior pre-fetch operations that have not yet been completed may no longer be needed as the user may have already moved passed those media items, or the priority for those operations may need to be changed as the location of those media items with respect to the current visible area may have changed. In order to enable quick cancelation, all operations may have cancelation points between each step.

Once prior pending pre-fetch operations are canceled, the operation 500 may schedule pre-fetch operations for retrieving high resolution versions of media items for any media items that is identified as being part of the final destination visible area (block 512). As discussed above, this can be done by calculating the rate of scrolling and deceleration and determining what area of the media arrangement will be included in the final destination once scrolling stops. Because the user will likely spend more time viewing the stationary part of the media arrangement, quality may be of more importance for the final destination and as such high resolution pre-fetch operations may be scheduled for those media items. The pre-fetch operations scheduled are similar to the operation 470 in that they include steps for determining if the high resolution version of the media item is available at the high resolution cache and if not retrieving the high resolution version, storing it at the disk cache, decompressing it, and then storing it in the high resolution cache. It should be noted that these high resolution pre-fetch operations may be scheduled concurrently with the low resolution pre-fetch operations of block 508. However, high resolution pre-fetch operations may receive a lower priority than low resolution pre-fetch operations. Additionally, in one embodiment, a high resolution pre-fetch operation for each media item may be dependent on the low resolution pre-fetch operation for that media item. As such the high resolution operation may not occur until the low resolution operation has completed.

When at block 504 it is determined that the visible area is not changing (i.e., there is no scrolling and the visible area is stationary), operation 500 may load high resolution media items into the visible media frames (block 514). This may be done to improve the quality of the user experience by providing high resolution media items when the user is likely to spending more time viewing the media frames due to the stationary status of the media arrangement. Steps involved in the loading of high resolution media items may include determining if the high resolution media item is available at the high resolution cache and if not going to operation 470 to retrieve the high resolution version, before loading it.

Once high resolution media items have been loaded for the visible media frames, operation 500 may identify media items corresponding to areas of the media arrangement that are adjacent to the currently visible area. Such media items may be identified for performing pre-fetching operations (block 516). The number of media items that may be identified for pre-fetching may vary. In one embodiment, the operation may identify media items that correspond to one area to the left and one area to the right of the currently visible area, each identified area corresponding to the size of the visible area. In other words, the operation may identify media items that may be made visible next in either direction of scrolling. In one embodiment, the operation may identify media items corresponding to ‘n’ areas to the left (e.g., four) and ‘m’ areas to the right (e.g., four) of the current visible area for a total of n m (e.g., 8) visible areas. Assuming that each visible area includes an average of about 16 media frames, this means up to 128 media items may be pre-fetched. Considering an average size of about 64 KB per low resolution media item, this may require about 8 MB to 10 MB of memory space, when all media items are decompressed, which will most likely not exceed the memory storage constraints of the device.

After identifying the media items for which pre-fetch operations should be performed, operation 500 may schedule low resolution pre-fetch operations for retrieving the low resolution version of the identified media items (block 516). The pre-fetch operations scheduled may be similar to the operation 450 in that they may include steps for determining if the low resolution version of the media item is available at the low resolution cache and if not retrieving the low resolution version, storing it at the disk cache, decompressing it, and then storing it in the low resolution cache.

In one embodiment, similar to the scheduling of block 508, the pre-fetch operations may be scheduled in order of priority by giving higher priority to media items that will be viewable closest to the current visible area. Thus, those media items that are closest to the edge of the current visible area may be given the highest priority. After scheduling these pre-fetch operations, the procedure may cancel all other previously pending pre-fetch operations (not the ones that were just scheduled) (block 520). That is because, as there's no scrolling occurring at the moment, all other previously scheduled pre-fetch operations may have the wrong priority or they may no longer be needed.

Once previously pending pre-fetch operations are canceled, operation 500 may move to schedule high resolution pre-fetch operations for certain identified media items. Generally, these may be scheduled for media items that correspond to areas adjacent to the current visible area and are a subset of the media items identified in block 516. For example, if block 516 identifies media items corresponding to four areas to the left and four areas to the right of the current visible area, block 522 may schedule high resolution pre-fetch operations for media items corresponding to one area to the left and one area to the right of the current visible page. That is because high resolution pre-fetch operations may take longer to complete and may require more memory. As such they may only be performed for areas immediately next to the currently visible area. Similar to the high resolution pre-fetch operations of block 512, the pre-fetch operations of block 522 may also be scheduled at the same time as the low resolution pre-fetch operations of block 518, but the high resolution operations may receive lower priority and they may be dependent on the low resolution operation being completed first.

As discussed above, in order to efficiently pre-fetch and load media items into media frames of a media arrangement, multiple operations may be scheduled and/or occurring at the same time in different threads and/or different queues. In order for all of the operations to work effectively together and to reach a fast frame-per-second rate for the media arrangement (e.g., 60 frames-per-second), thread and scheduling priorities may need to be made. In one embodiment, loading of low resolution media items into a media frame (operations 400 and 420) may be granted the highest scheduling and thread priority. Such operations may occur at the main thread and may be given the designation of Very High Priority. Operations involving retrieving of low resolution media times (operation 450) may also be designated as Very High Priority operations when they are performed in order to load a media frame as part of operation 400. However, these low resolution retrieval operations may occur at a secondary thread. The next priority level, Normal Priority, may be given to loading high resolution media items such as operation 422 which may also occur at the main thread. Retrieval of high resolution media items (operation 470) may also receive a Normal Priority designation when such an operation is performed as part of loading a media frame. However, the retrieval operation may be performed at a secondary thread. Pre-fetch operations for retrieving low resolution media items receive the next designation which is Low Priority, while pre-fetch operations for retrieving high resolution media items receive the lowest priority level, Very Low Priority.

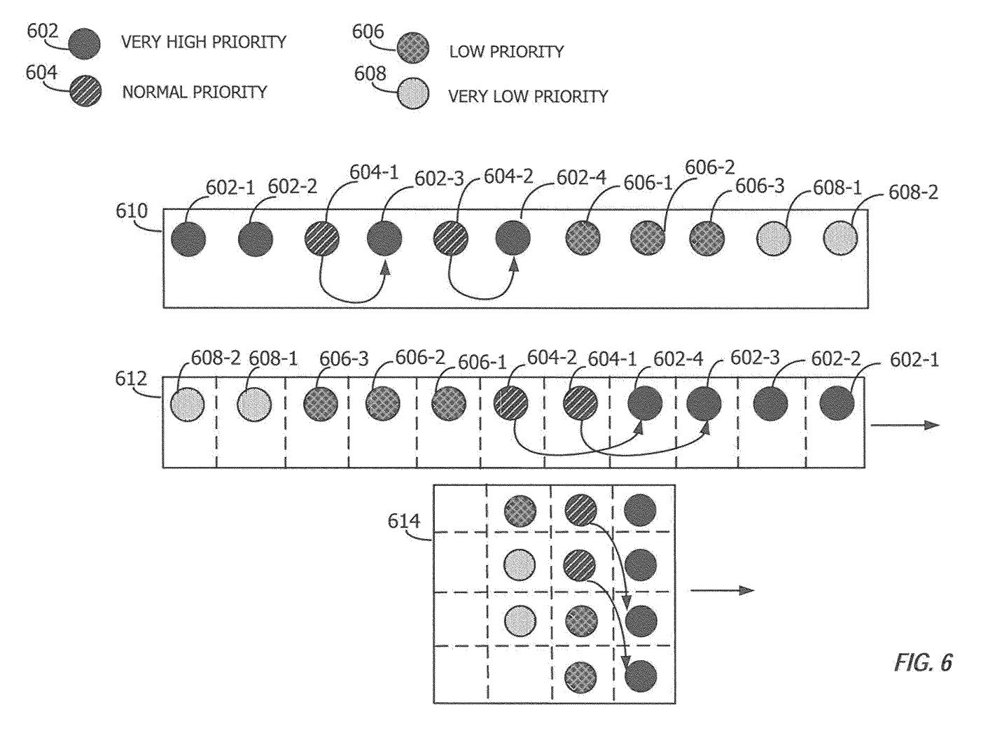

FIG. 6 provides an example of how operations having different priorities are put into order. Different shades of circles are used in FIG. 6 to show operations having different priorities. Circle 602 is used to illustrate operations having a Very High Priority, while circle 604 is used to show operations having Normal Priority. Additionally, circle 606 is used for operations having Low Priority and circle 608 is used for operations having Very Low Priority. If operations shown in box 610 need to performed, the system may schedule them in the operations queue accordance with the order shown in box 612. Thus, the four operations 602-1, 602-2, 602-3, 602-4 are given highest priority but are themselves scheduled in order of priority they were given (i.e., 602-1 is scheduled before 602-2, etc.). Operation 604-1 is of lower priority than operations 602 and is dependent upon operation 602-3, thus it is schedule after 602-4, while its dependency to 602-3 is noted so that it will have to have its' dependency resolved before being performed. Similarly, operation 604-2 is schedule after operations 602 and after operation 604-1, while its' dependency to operation 602-4 is noted. Operations 606-1 and 606-2 are scheduled after operations 602 and 604 and operations 608-1 and 608-2 are scheduled after operations 602, 604 and 606.

In the operations queue 614 having a depth of four, the operations shown in box 610 may be scheduled such that all four of the 602 operations are performed first. Operations 604 will be next in the queue after operations 602-3 and 602-4 are completed. Next, operations 606 will be performed in order, and then finally operations 608 will be done at the end of the queue. Thus, by using thread priority and operations scheduling priority, embodiments described herein provide an efficient progressive method of loading and retrieving media items for a media arrangement that reduces the number blank media frames presented to the user and provides high resolution media items when possible and/or needed.

Additionally, in one embodiment, in an independent background thread running at a very low priority, all media items from services not cached on cache disk 300 may be pre-loaded in order to reduce latencies. This may involve operations such as updating media items that have not been to a local metadata cache and/or retrieving low resolution media items in a low priority thread designated for such tasks. Such operations may be performed as long as no other operations are being run. When the visible area starts changing, this background routine may be paused so it does not interfere with the other operations. This operation may be stopped in one embodiment, if the visible area begins changing.

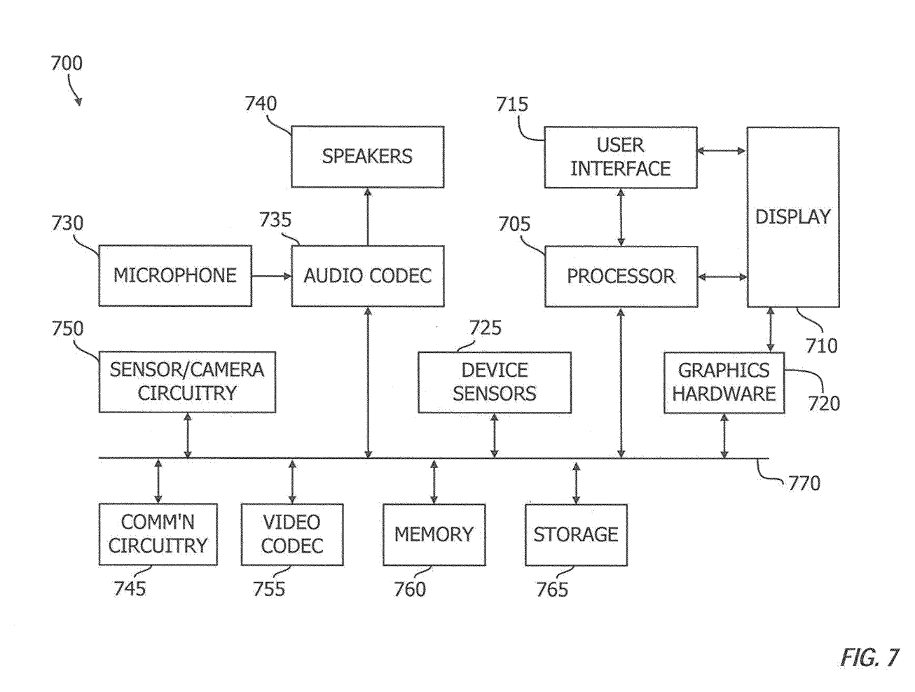

Referring to FIG. 7, a simplified functional block diagram of illustrative electronic device 700 is shown according to one embodiment. Electronic device 700 may include processor 705, display 710, user interface 715, graphics hardware 720, device sensors 725 (e.g., proximity sensor/ambient light sensor, accelerometer and/or gyroscope), microphone 730, audio codec(s) 735, speaker(s) 740, communications circuitry 745, digital image capture unit 750, video codec(s) 755, memory 760, storage 765, and communications bus 770. Electronic device 700 may be, for example, a digital camera, a personal digital assistant (PDA), personal music player, mobile telephone, server, notebook, laptop, desktop, or tablet computer. More particularly, the disclosed techniques may be executed on a device that includes some or all of the components of device 700.

Processor 705 may execute instructions necessary to carry out or control the operation of many functions performed by device 700. Processor 705 may, for instance, drive display 710 and receive user input from user interface 715. User interface 715 can take a variety of forms, such as a button, keypad, dial, a click wheel, keyboard, display screen and/or a touch screen. Processor 705 may also, for example, be a system-on-chip such as those found in mobile devices and include a dedicated graphics processing unit (GPU). Processor 705 may be based on reduced instruction-set computer (RISC) or complex instruction-set computer (CISC) architectures or any other suitable architecture and may include one or more processing cores. Graphics hardware 720 may be special purpose computational hardware for processing graphics and/or assisting processor 705 to process graphics information. In one embodiment, graphics hardware 720 may include a programmable graphics processing unit (GPU).

Sensor and camera circuitry 750 may capture still and video images that may be processed, at least in part, in accordance with the disclosed techniques by video codec(s) 755 and/or processor 705 and/or graphics hardware 720, and/or a dedicated image processing unit incorporated within circuitry 750. Images so captured may be stored in memory 760 and/or storage 765. Memory 760 may include one or more different types of media used by processor 705 and graphics hardware 720 to perform device functions. For example, memory 760 may include memory cache 305, read-only memory (ROM), and/or random access memory (RAM). Storage 765 may store media (e.g., audio, image and video files), computer program instructions or software, preference information, device profile information, and any other suitable data. Storage 765 may include one or more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Persistent disk cache 300 may be maintained within at least a portion of storage 765. Memory 760 and storage 765 may also be used to tangibly retain computer program instructions or code organized into one or more modules and written in any desired computer programming language. When executed by, for example, processor 705 such computer program code may implement one or more of the operations described herein.

It is to be understood that the above description is intended to be illustrative, and not restrictive. The material has been presented to enable any person skilled in the art to make and use the inventive concepts described herein, and is provided in the context of particular embodiments, variations of which will be readily apparent to those skilled in the art. For example, some of the disclosed embodiments may be used in combination with each other. As another example, an implemented cache system may use more than three levels. Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A non-transitory program storage device, readable by a processor and comprising instructions stored thereon to cause one or more processors to:
identify a media frame associated with a media arrangement;
associate a media item with the identified media frame;
load a first resolution of the media item into the media frame, when a visible area of the media arrangement is changing and the first resolution of the media item is available at a first memory; and
load a second resolution of the media item into the media frame when at least one of the following is true:
the second resolution is available at a second memory and the visible area of the media arrangement is not changing, or
the second resolution is available at a second memory and the media frame is determined to be part of a final visible area of the media arrangement,
wherein the first resolution is lower than the second resolution.

2. The non-transitory program storage device of claim 1, wherein the instructions to cause the one or more processors to load the first resolution of the media item into the media frame further comprise instructions to cause the one or more processors to:
determine if the first resolution of the media item is available at a third memory when the first resolution is not available at the first memory;
load the first resolution of the media item into the media frame when available;
retrieve the first resolution of the media item from a source when the first resolution is not available at the first memory and is not available at the third memory;
store the retrieved first resolution of the media item in the third memory;
decompress the retrieved first resolution;
store the decompressed first resolution into the first memory; and
load the decompressed first resolution into the media frame.

3. The non-transitory program storage device of claim 1, wherein the instructions to cause the one or more processors to load the second resolution of the media item into the media frame further comprise instructions to cause the one or more processors to load the first resolution of the media item into the media frame when it is determined that the second resolution is not available at the second memory.

4. The non-transitory program storage device of claim 3, wherein the instructions to cause the one or more processors to load the second resolution of the media item into the media frame further comprise instructions to cause the one or more processors to:
determine if the second resolution of the media item is available at a third memory when the second resolution is not available at the second memory;
load the second resolution of the media item into the media frame when available;
retrieve the second resolution of the media item from a source when the second resolution is not available at the second memory and is not available at the third memory;
store the retrieved second resolution of the media item in the third memory;
decompress the retrieved second resolution;
store the decompressed second resolution into the first memory; and
load the decompressed second resolution into the media frame.

5. The non-transitory program storage device of claim 1, wherein the instructions to cause the one or more processors further comprise instructions to cause the one or more processors to:
identify a visible area of a media arrangement;
identify a plurality of upcoming media items associated with the media arrangement, each of the plurality of upcoming media items being intended for presentation outside the visible area of the media arrangement;
schedule retrieval of a first resolution of one or more of the plurality of upcoming media items that are not determined to be part of a final visible area of the media arrangement, when the visible area is changing; and
schedule retrieval of a second resolution of one or more of the plurality of media items that are determined to be part of the final visible area of the media arrangement, when the visible area is changing.

6. The non-transitory program storage device of claim 5, wherein the program code to cause the one or more processors to retrieve a first resolution of one or more of the plurality of media items further comprises program code stored in memory to:
retrieve a first resolution of the one or more media items from a source, if the first resolution is not available at a first memory;
store the retrieved first resolution in the first memory;
decompress the retrieved first resolution; and
store the decompressed first resolution into a second memory.

7. The non-transitory program storage device of claim 5, wherein the program code to cause the one or more processors to retrieve a first resolution of one or more of the plurality of media items further comprises program code stored in memory to:
decompress the first resolution of the one or more media items, if the first resolution is available at a first memory; and
store the decompressed first resolution into a second memory.

8. The non-transitory program storage device of claim 5, wherein the program code to cause the one or more processors to retrieve a second resolution of one or more of the plurality of media items further comprises program code stored in memory to:
retrieve a second resolution of the one or more media items from a source, if the second resolution is not available at a first memory;
store the retrieved second resolution in the first memory;
decompress the retrieved second resolution; and
store the decompressed second resolution into a third memory.

9. The non-transitory program storage device of claim 5, wherein the program code to cause the one or more processors to retrieve a second resolution of one or more of the plurality of media items further comprises program code stored in memory to:
decompress the second resolution of the one or more media items, if the second resolution is available at a first memory; and
store the decompressed second resolution into a third memory.

10. A device, comprising:
a memory;
a display device; and
one or more processors operatively coupled to the memory and the display device, the one or more processors configured to execute program code stored in the memory to:
identify a media frame associated with a media arrangement;
associate a media item with the identified media frame;
load a first resolution of the media item into the media frame, when a visible area of the media arrangement is changing and the first resolution of the media item is available at a first memory; and
load a second resolution of the media item into the media frame when at least one of the following is true:
the second resolution is available at a second memory and the visible area of the media arrangement is not changing, or
the second resolution is available at a second memory and the media frame is determined to be part of a final visible area of the media arrangement,
wherein the first resolution is lower than the second resolution.

11. The device of claim 10, wherein the one or more processors are further configured to execute program code stored in the memory to:
identify a plurality of upcoming media items associated with the media arrangement, each of the plurality of upcoming media items being intended for presentation outside the visible area of the media arrangement;
schedule retrieval of a first resolution of one or more of the plurality of upcoming media items that are not determined to be part of a final visible area of the media arrangement, when the visible area is changing; and
schedule retrieval of a second resolution of one or more of the plurality of media items that are determined to be part of the final visible area of the media arrangement, when the visible area is changing.

12. The device of claim 11, wherein the retrieval of a first resolution of the one or more of the plurality of media items is scheduled according to a priority schedule.

13. The device of claim 11, wherein the retrieval of a second resolution of the one or more of the plurality of media items is scheduled according to a priority schedule.

14. The device of claim 11, wherein the plurality of media items are media items intended for presentation in an area of the media arrangement that is located in the direction of change of the visible area.

15. The device of claim 11, further comprising an image capture device.

16. A method, comprising:
identifying a media frame associated with a media arrangement;
associating a media item with the identified media frame;
loading a first resolution of the media item into the media frame, if a visible area of the media arrangement is changing and the first resolution of the media item is available at a first memory; and
loading a second resolution of the media item into the media frame when the second resolution is available at a second memory, if the visible area of the media arrangement is not changing or if the visible area is changing and the media frame is determined to be part of a final visible area of the media arrangement;
wherein the first resolution uses a lower speed than the second resolution.

17. The method of claim 16, wherein loading the first resolution media item into the media frame further comprises:
determining if the first resolution of the media item is available at a third memory when the first resolution is not available at the first memory;
loading the first resolution of the media item into the media frame when available;
retrieving the first resolution of the media item from a source when the first resolution is not available at the third memory;
storing the retrieved first resolution in the third memory;
decompressing the retrieved first resolution;
storing the decompressed first resolution into the first memory; and
load the decompressed first resolution into the media frame.

18. The method of claim 16, further comprising loading the first resolution of the media item into the media frame when it is determined that the second resolution is not available at the second memory.

19. The method of claim 16, wherein loading the second resolution of the media item into the media frame comprises:
determining if the second resolution of the media item is available at a third memory when the second resolution is not available at the second memory;
loading the second resolution of the media item into the media frame when available;
retrieving the second resolution of the media item from a source when the second resolution is not available at the third memory;
storing the retrieved f second resolution in the third memory;
decompressing the retrieved second resolution;
storing the decompressed second resolution into the first memory; and
loading the decompressed second resolution into the media frame.

20. The method of claim 16, wherein the first memory comprises low resolution memory cache.
